(19) United States
(12) Patent Application Publication
(10) Pub. No.: US 2003/0177213 A1
(43) Pub. Date: Sep. 18, 2003

(54) Determining connectivity in communication networks

(76) Inventors: Chris E. Wallace, Nepean (CA); Gregory M. McCloskey, Jordanstown (GB); Kristina M. Cherwenka, Ottawa (CA); Hung M. Truong, Ottawa (CA)

Correspondence Address: William M. Lee, Jr., LEE, MANN, SMITH, MCWILLIAMS, SWEENEY & OHLSON, P.O. Box 2786, Chicago, IL, 60690-2786, US

(21) Appl. No.: 10/051,930

(22) Filed: Jan. 18, 2002

(51) Int. Cl. G06F 15/173; H04L 9/00

(52) U.S. Cl. 709/223; 713/201

(57) ABSTRACT

The connectivity of the nodes in a communication network operated by a network manager is determined by transmitting unique signatures from the nodes and detecting them at other nodes. The network manager correlates the detected signatures and thereby derives the connectivity. One-way trails are established by the detection at one node of a signature sent by another node. When one-way trails are established between the same two nodes, a bidirectional trail is established. This enables connectivity in other layers of the network protocol to be determined.

### FIELD OF THE INVENTION

The present invention is concerned broadly with techniques for the generation of information relating to the connectivity of nodes in a communications network. In particular, the invention relates to a network and to methods of operating networks in which the derivation of connectivity information is automatic.

### BACKGROUND OF THE INVENTION

A known system for operating a communication network involves the use of templates to mirror various functionalities and connectivities of the nodes within the network. Reference may be had to U.S. Pat. No. 6,223,219 for detailed explanation of this mode of operation and the manner in which templates are used to manage the network. The network is intended to be under the control of a Network Manager, a piece of software that “sits” at the top of the management tree and supervises the operation of the system and, in particular, the templates. The templates store connectivity and functionality data (on a physical and logical layer basis, in accordance with well-established communications protocols) and thereby represent the “trail” or path connecting one network node to another. For this reason, the piece of software described in the above U.S. patent and utilised in the present invention is known as the “Trail Manager”.

Templates are reckoned to be a powerful tool that not only enhance the operation of the network but also relieve the network operator from many of the tasks involved in updating the Network Manager whenever changes occur within the network. In order for a Trail Manager to operate, it requires information about the physical connectivity of the components it is managing. Specifically, for each endpoint that it manages, Trail Manager must know its neighbouring endpoint. For example, when a change occurs in the connectivity of a node (referred to generically in this specification as a network element or NE) those changes have to be reflected in the corresponding template for that NE. This has hitherto involved manual entry of the relevant connectivity and functionality data into the network manager. Currently, this physical connectivity is entered in a text file. Operators use part of the software (for example that known in the context of the above U.S. patent application as the Netbuild tool) to read the text file and store the information in the Trail Manager database. Most text files are manually generated by the operator. Any time physical connectivity changes, text files must be manually created to reflect the changes in the network, and, once again, the Netbuild tool must be invoked by an operator to update the database. It can involve many hours of work and is disruptive to the network and obviously prone to error.

### SUMMARY OF THE INVENTION

The present invention aims to provide an automatic alternative to the need identifed above for manual intervention in updating the management system of a communication network and especially the database in a network manager utilising templates. More particularly, in a preferred implementation, the invention will allow network elements to automatically discover their physical connectivity, which will greatly reduce the number of text files that must be manually generated, and the versatility of the network will be greatly improved by removing the need for manually updating physical connectivity by an operator.

Acordingly, the invention provides, in a first aspect, a method for determining the connectivity of nodes in a communication network comprising a plurality of interconnected nodes, the method comprising transmitting into the network a signal from each node, the signal constituting a signature unique to that node, detecting unique signature data from every transmitter and receiver, and correlating the detected data to determine the physical connectivity of the network.

In this method, each node may report transmission of a unique signature and detection of a unique signature to a network manager controlling the network. Advantageously, a node that was previously receiving a valid unique signature does not report detection of an invalid signature, whereby to prevent the network manager effecting changes under fault conditions.

Preferably, under circumstances in which a node has not detected a unique signature matching a transmitted signature, the network manager creates an off-network pointer for the said node. A unidirectional trail may be established in the network manager from a second node to a first node when the first node detects the unique signature of the second node; establishing a unidirectional trail in the network manager from the first node to the second node when the second node detects the unique signature of the first node; and thereby establishing a bidirectional trail between the first node and the second node.

In a second aspect, the invention also provides a communication network comprising a plurality of interconnected nodes, the network provided with means for determining the connectivity of said nodes, comprising a transmitter per node for transmitting into the network a signature signal from each node, the signal constituting a signature unique to that node, a detector per node for detecting unique signature data received at each said node, and a correlator for correlating the detected unique signature data to determine the physical connectivity of the network.

Consistent with the above method, the communication network preferably further comprises reporting means whereby each node reports transmission of a unique signature and detection of a unique signature to a network manager controlling the network. The network may also comprise blocking means whereby a node that was previously receiving a valid unique signature does not report detection of an invalid signature, whereby to prevent the network manager effecting changes under fault conditions.

The communication network may further comprise off-network pointer creating means whereby, when a node has not detected a unique signature matching a transmitted signature, the network manager creates an off-network pointer for that node.

The communication network may further comprise trail establishing means whereby to establish a unidirectional trail in the network manager from a second node to a first node when the first node detects the unique signature of the second node; establish a unidirectional trail in the network manager from the first node to the second node when the second node detects the unique signature of the first node; and thereby to establish a bidirectional trail between the first node and the second node.

The network may be an optical communication network.

In a third aspect, the invention provides a network manager for a communication network, the communication network comprising a plurality of interconnected nodes, the network manager provided with correlator means for determining the connectivity of said nodes in response to detection at each node of unique signature signals transmitted into the network from each node, said correlator means adapted to correlate the detected unique signature signals to determine the physical connectivity of the network.

The invention yet further provides a media carrying a computer program adapted to perform the method or the function of the network manager and a computer program adapted to perform that function.

In preferred embodiments, the network manager derives connectivity using information from various auto-discovery techniques such as “stolen bytes in line overhead” and wave id. It is also beneficial if the network manager is capable of deriving changes in connectivity using information from various auto-discovery techniques, if it provides users with the option of disabling autodiscovery so that trails will never automatically be modified in the database that are not already in the Network Learned state. In addition, it is preferable for users to be given the option of enabling autodiscovery without enabling network change. When this occurs, trails will only be enrolled in the database if the endpoints are not already in use by another trail. It is also preferable that users have the option of enabling autodiscovery with network change. Under these circumstances, the network manager will enroll in its database any physical connectivity that can be discovered from the network without manual invocation by the operator.

When autodiscovery and network change are enabled, it is preferable for the network manager to update any changes to physical connectivity that can be discovered from the network without requiring an operator to manually invoke changes. Autodiscovery may generate a log file that records any additions, deletions and changes to physical connnectivity that were automatically made by Autodiscovery. As an enhancement to the system, Autodiscovery may provide Managed Operation Agents with the option to opt out of automatically applying autodiscovered trails.

As a corollary of these features, any NE that does not support autodiscovery may have to be cut into the network using another network manager tool, such as the Netbuild tool mentioned above. In addition, if the network notifies Trail Manager that some physical connectivity has been deleted from the network and this physical connectivity supports a logical trail in the NotReadyForService state, the physical connectivity will not be deleted. A log message will be generated to reflect this. Moreover, if the network notifies Trail Manager that some physical connectivity has been deleted from the network and this physical connectivity supports a logical trail with scheduled information, the physical connectivity will not be deleted. A log message will be generated to reflect this. Again, if the network notifies Trail Manager that some physical connectivity has been deleted from the network and this physical connectivity supports a logical trail that has a protection loop that is opened but not closed, the physical connectivity will not be deleted. A log message will be generated to reflect this.

It is preferable that a user will not be able to turn autodiscovery on or off from a User Interface (UI). Instead, an installation script will be used. Autodiscovery has the capacity to build trails on unidirectional endpoints whenever possible. If trails were built on bidirectional endpoints and these trails are autodiscovered, autodiscovery will delete these trails and replace them with trails on unidirectional endpoints, assuming unidirectional endpoints exist. Consequently, many logical trails mayl be split and rejoined, even though the connectivity in the network has not really changed. This will only occur during the first startup alignment and will only occur if autodiscovery and network change are enabled. This change will not cause any user-entered data in the logical trails to be lost. Trails will not be modified if autodiscovery is enabled but network change is disabled. Consequently, if a user has built trails using bidirectional endpoints and then wishes to use unidirectional endpoints, the user must force delete all logical trails and physical trails, then enroll the new trails on the unidirectional endpoints.

In the embodiments that follow, three modes of operation will be described. There are also three options for switching on/off auto-discovery, namely:

disable autodiscovery

enable autodiscovery without network change

enable autodiscovery with network change

When auto-discovery is turned on with network change, autodiscovery will assume that all trails that exist in the database have the network adjustable policy. Consequently, these trails will be modified during network reconfigurations.

When autodiscovery is turned on without network change, Trail Manager will assume that all trails that exist in the database have a locked policy. Autodiscovery will not take any action when it discovers that a trail already exists on one of the endpoints specified in the trail notification. Consequently, enabling autodiscovery without enabling network change only allows trails to be enrolled in a “green field” situation.

When auto-discovery is turned off, Trail Manager will not modify trails in the database in any way. A log entry will be generated for all events that come from the network.

The preferred features as described hereinabove or as described by any of the dependent claims filed herewith may be combined, as appropriate, as would be apparent to a skilled person, and may be combined with any of the aspects of the invention as described hereinabove or as described by any of the independent claims filed herewith.

### BRIEF DESCRIPTION OF THE DRAWINGS

The invention will now be described with reference to the following drawings, in which:

FIG. 1 represents a decision tree for trail messages;

FIGS. 2, 3 and 4 represent part of a network in which the invention may be implemented;

FIG. 5 illustrates the trail enroll decision tree;

FIG. 6 illustrates the de-enroll decision tree;

FIG. 7 illustrates the trail accept decision tree;

FIGS. 8 through 22 are schematic diagrams of various states of the network as the invention progresses;

FIG. 23 is a representation of the Trail State Machine;

FIG. 24 is a schematic illustration of the use of next neighbour information;

FIG. 25 is a schematic illustration of a fibre physical layer;

FIG. 26 is a schematic illustration of a SONET section layer;

FIG. 27 is a schematic illustration of a SONET line layer;

FIGS. 28 and 29 are schematic illustrations of the layers required to implement a particular amplifier program; and

FIG. 30 is an exemplary flow diagram illustrating the use of auto-discovery in an implementation of the invention.

### DETAILED DESCRIPTION OF THE ILLUSTRATED EMBODIMENTS

Determining Physical Connectivity

There are various techniques that can be used to determine the topology of a network. Currently, topological data is manually entered by operators as part of setting up the network. Hitherto, only the physical connectivity of transport optics has been stored but not the physical connectivity of tributaries. NE-auto discovery allows physical connectivity to be discovered on transport optics as well as tributaries. NE-Auto Discovery involves transmitting a unique signature in spare bytes in the SONET line overhead. Trail Manager collects the unique signature from every transmitter and receiver, and correlates the data to determine the physical connectivity of the network.

In the context of Trail Manager, a subsytem known as tmserver registers for certain events via a function known as the ems_initiate_event_reporting function. When this function is called, a filter is specified so that only events relating to pADMpConfig and RingConfig objects are reported to tmserver. Once the trail manager core has established a session with tmserver, the trail core requests a list of NEs, then a list of endpoints, and then a list of trails.

Currently, when tmserver reports its list of trails, it simply reports the connectivity between transport optics. When a request for trails is received, a series of messages (known as cmise messages) are sent to each NE requesting auto-discovery data from each facility on that NE.

Each facility will return the following information:

auto-discovery enabled? TRUE/FALSE

auto-discovery data reliable? (is there a signal from which to read the auto-discovery data?) TRUE/FALSE

direction Tx/Rx

auto-discovery technique (i.e. line o/h version 1)

auto-discovery signature (i.e. the unique signature that is transmitted or received)

Tmserver will then construct a xdr_tmcom_trail_info structure and fill it in with the above information. For example, an OC192 transmitter would fill in the structure with MS autodiscovery information as follows:

struct xdr_tmcorn_trail_info

xdr_tmcom_trail_points trail_points = {

u_short first_ne = 4817;
xdr_tmcom_universal_location first_endpoint = {

u_char shelf = 0;
u_char sub_shelf = 0;
u_char slot = 7;
u_char sub_slot = 0;
u_char port_number = 1;
u_short endpoint_instance = 0;
struct {

u_int payload_index_len = 0;
u_short *payload_index_val = NULL;

} payload_index;
xdr_tmcom_tp_class tp_class = xdr_tmcom_ctp_tp_class;
xdr_tmcom_tp_details tp_details = {

xdr_tmcom_tp type tp_type = xdr_tmcom_MS;
xdr_tmcom_tp type_qualifier tp_qualifier =

xdr_tmcom_STM64;

struct }

u_int tp_sub_type_list_len = 3;
xdr_tmcom_tp_sub_type_list_val[1] =

char* tp_sub_type_name =

“!R=$S:AutodiscoveryEnabled”

char* tp_sub_type_value = “TRUE”;

xdr_tmcom_tp_sub_type_list_val [4] =

char* tp_sub_type_name =

“!R=$S:AutodiscoveryReadable”

char* tp_sub_type_value = “TRUE”

xdr_tmcom_tp_sub_type_list_val[4] =

char* tp_sub_type_name =

“!R=$S:AutodiscoverySignatureTx”

char* tp_sub_type_value =

“MACAddress:0:0:7:0:1”

}tp_sub_type_list;

};

xdr_tmcom_directionality direction =

xdr_tmcom_bidirectional;

};

u_short second_ne = 0;
xdr_tmcom_universal_location second_endpoint =

u_char shelf = 0;
u_char sub_shelf = 0;
u_char slot = 0;
u_char sub_slot = 0;
u_char port_number = 0;
u_short endpoint_instance = 0;
struct {

u_int payload_index_len = 0;
u_short *payload_index_val = NULL;

} payload_index;
xdr_tmcom_tp_class tp_class = xdr_tmcom_null_tp_class;
xdr_tmcom_tp_details tp_details = {

xdr_tmcom_tptype tp_type = xdr_tmcom_null_tp_type;
xdr_tmcom_tp_type_qualifier tp_qualifier =

xdr_tmcom_null_qualifier;

struct }

u_int tp_sub_type_list_len;
xdr_tmcom_tp_sub_type *tp_sub_type_list_val
= NULL;

} tp_sub_type_list;

} ;
xdr_tmcom_directionality direction =

xdr_tmcom_unidirectional;

} ;

} ;
char *user_label = “ ” ;
char *customer_label = “ ”;
xdr_tmcom_tpdetails ttp_type = xdr_tmcom_ctp_tp_class;
xdr_tmcom_simple_control trail_adjustment_prevented = xdr_tmcom_on;
xdr_tmcom_directionality directionality = xdr_tmcom_bidirectional;
};

This structure would then be returned to the trail core in response to a xdr_tmcom_get_trails request.

The value of the directionality in the universal location structure should represent the directionality of the termination point at the layer specified in the universal location. The value of the directionality in the trail_info structure should represent the directionality of the trail at the specified layer. The fact that this autodiscovery signature exists on a transmitter—as opposed to a receiver—is captured in the “AutodiscoverySignatureTx” attribute.

If the trail is a unidirectional trail, the first endpoint should have a directionality of unidirectional_tx and the second endpoint should have a directionality of unidirectional_rx.

When any of the data on the facility changes, a cmise event will be sent to tmserver. When tmserver detects an event on a facility, it generates a xdr_moatm_enroll_trail event. This event message will contain the xdr_tmcom_trail_info structure that was described above. This structure will be filled in with the new data. Tmserver must respond to changes in auto-discovery data by reporting xdr_moatm_enroll_trail events to Trail Manager.

In order for Trail Manager to store this auto-discovery data in the mobCEndpoint objects, the endpoint templates include the following TPAM attributes:

AutodiscoveryEnabled

AutodiscoveryReadable

AutodiscoverySignatureTx

AutodiscoverySignatureRx

These attributes will be defined in the endpoint templates at the appropriate layers. For the technique involving “stolen bytes in the line overhead”, the layer would be the MS layer. For the wave id technique, the layer would be the OTS layer.

The attributes are defined as follows:

Auto-Discovery Enabled:

struct xdr_tmcom_tp_sub_type

char *tp_sub_type_name = “ ?D-AutodiscoveryEnabled”
char *tp_sub_type_value = “ ?T=$E:TRUE,FALSE;?S=trl”;

char *tp_sub_type_null_equals = NULL;
xdr_tmcom_tp_match_enforce end_to_
end_match = FALSE;

} ;

The TPAM definition described above allows the “Auto-Discovery Enabled” attribute to have a value of TRUE or FALSE. The definition also indicates that the source of the attribute value will be reported in a trail message.

Auto-Discovery Readable:

struct xdr_tmcom_tp_sub_type

char *tp_sub_type_name = “ ?D=AautodiscoveryReadable”
char *tp_sub_type_value = “ T=$E:TRUE,FALSE;?S=trl”

char *tp_sub_type_null_equals = NULL;
xdr_tmcom_tp_match_enforce end_to_
end_match = FALSE;

} ;

The TPAM definition described above allows the “Auto-Discovery Readable” attribute to have a value of TRUE or FALSE. The definition also indicates that the source of the attribute value will be reported in a trail message.

Auto-Discovery Data on Receivers:

struct xdr_tmcom_tp_sub_type

char *tp_sub_type_name = “ ?D=Autodiscovery
SignatureRx”
char *tp_sub_type_value = “ ?T=$C:#sys$F:oft;?S=trl;”

char *tp_sub_type_null_equals = NULL;
xdr_tmcom_tp_match_enforce end_to_
end_match = FALSE;

} ;

Auto-Discovery Data on Transmitters:

struct xdr_tmcom_tp_sub_type }

char *tp_sub_type_name = “?D=Autodiscovery
SignatureTx”;
char *tp_sub_type_value = “T=$C:#s;?C=$sys$F:oft;?S=trl;”

char *tp_sub_type_null_equals = NULL;
xdr_tmcom_tp_match_enforce end_to_
end_match = FALSE;

} ;

The TPAM definition described above allows the autodiscovery signature attribute to be represented as a string. There are no limits on the length of the string or the types of characters that are valid in the string. The autodiscovery signature can only be automatically changed by the system and this is likely to happen frequently. The definition indicates that the source of the attribute value will be reported in a trail message.

Interpretation of Auto-Discovery Data

Every facility that supports auto-discovery will be supplying the following information:

auto-discovery enabled? TRUE/FALSE

auto-discovery readable? TRUE/FALSE

layer

direction Tx/Rx

auto-discovery technique (i.e. line o/h version 1)

auto-discovery signature (i.e. the unique signature that is transmitted or received)

The “Auto-Discovery Enabled” attribute will indicate whether or not auto-discovery is turned on on a facility. If the attribute has a value of TRUE, it is assumed that the facility has auto-discovery enabled. It the attribute has a value of FALSE, it is assumed that the facility has auto-discovery disabled.

The “Auto-Discovery Readable” attribute will indicate whether or not it is possible to read the auto-discovery data.

The “layer” attribute will be used to determine the layer at which two entites are physically connected. If, for instance, two termination points are found to have the same auto-discovery signature at the MS layer, it is assumed that those two termination points are connected at the MS layer.

The “layer” attribute will be reported to the Trail Core in the xdr_tmcom_trail_info structure in its universal_location->tp_details->tp_type & tp_qualifier attributes.

The “direction” attribute will be used to locate the termination point at the specified layer. Consequently, the direction attribute should have a value of bidirectional for all MS-line autodiscovery signatures. This attribute will be reported to the Trail Core in the xdr_tmcom_trail_info structure—in its universal_location->direction attribute.

The “auto-discovery signature” attribute will be used to determine connectivity in the network. An auto-discovery signature is considered to be unique within the network on a per port basis. That is, only one port in the entire network will transmit a given signature. Similarly, only one port in the entire network will receive a given signature. When Trail Manager finds a given signature on a transmitter and a receiver, it will assume that those two ports are connected at the layer specified in the xdr message.

Auto-discovery data will be reported to the Trail Manager core in a xdr_moatm_list_of_trails message (in response to a xdr_tmcom_get_trails request), or in a xdr_moatm_enroll_trail asynchronous notification.

The NE—and consequently tmserver—will report auto-discovery information under the following conditions:

when an NE is commissioned or started up

when a readable/valid auto-discovery signature is received

when a different but reliable/valid auto-discovery signature is received

when auto-discovery is disabled or enabled

The NE will not report auto-discovery data when a port which was previously receiving a valid auto-discovery signature starts receiving an invalid auto-discovery signature. This will prevent Trail Manager from deleting trails when a fibre cut occurs.

In order to distinguish between fibre cuts and moving a fibre to a non-compatible NE, a procedure is invoked to disable auto-discovery before refibering and to enable auto-discovery when refibering is complete.

Correlation of Auto-Discovery Data

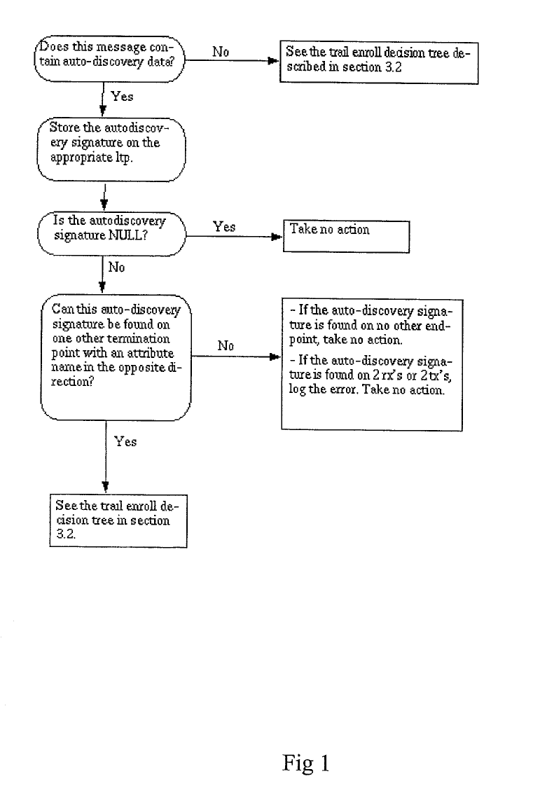

The flow chart in FIG. 1 illustrates how these messages will be interpreted. A simple example of the operation of the system under certain conditions will now be given.

Startup Alignment

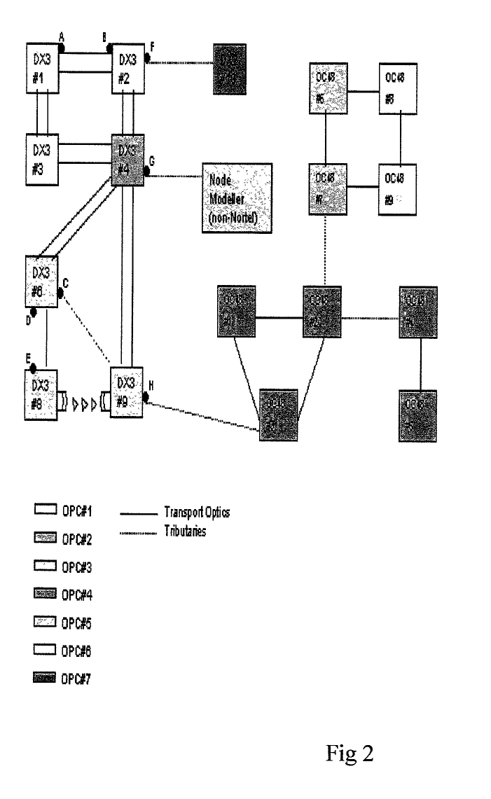

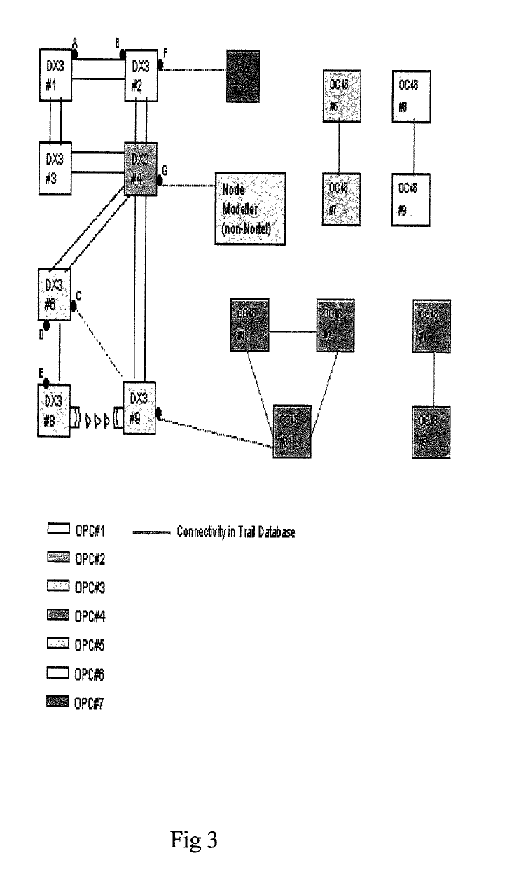

The assumption is that the following conditions apply: (a) Trail Manager is started for the FIRST time; (b) Trail Explorer has not been turned on; and (c) Trail Manager is managing the network as illustrated in FIG. 2.

By default, auto-discovery will be enabled on all facilities on all of the NEs. However, on one port (port C), auto-discovery has been turned off. On all other ports, auto-discovery is enabled. Auto-discovery data is reliable on all ports—except D and E—because of missing fibre.

Once Trail Manager has established a session with each of the OPCs, it will request physical connectivity data via an xdr_tmcom_get_trails message. OPC#4 will respond to this request with trails that contain no auto-discovery data and thus require no correlation. It will report the connectivity between the transport optics on all NEs in the configurations that it manages and that are in its span of control. Since the source of this data is from the Configuration Manager tool on the OPC, the loss of association on one of the NEs will have no impact on the data reported. Tributary connectivity will not be reported. Since Trail Manager is not aware of any logical trails at this point (Trail Explorer is turned off), the physical connectivity will be automatically enrolled. OPC #5 will respond to this request with trails that contain no auto-discovery data and thus requires no correlation. Although OPC#5 has 4 NEs in its configuration, it only has 2 in its span of control—so it will only report physical connectivity for the transport optics in between NEs in its own span of control. OPC#6 will behave similarly. Since Trail Manager is not aware of any logical trails at this point (Trail Explorer is turned off), the physical connectivity will be automatically enrolled. OPCs #1, 2 and 3 will respond to the xdr_tmcom_get_trails request with auto-discovery data that requires correlation.

If endpoint A reports its transmitter information first, a matching auto-discovery signature will not be found, so the transmitter will remain connected to an off-network pointer. If endpoint A then reports its receiver information, once again, a matching auto-discovery signature will not be found, so the receiver will also remain connected to an off-network pointer.

When endpoint B reports its transmitter information, a matching auto-discovery signature will be found on the receiver of endpoint A, and a unidirectional trail from B to A will be created. Since unidirectional trails can only exist at layers below the RS layer, only 5 trails will be created—at the PMS, OTS, OMS, TOP and DOP layers.

When endpoint B reports its receiver information, a matching auto-discovery signature will be found on the transmitter of endpoint B, and a unidirectional trail from A to B will be created. Because a unidirectional trail from B to A is also present on these endpoints, this will cause bidirectional trails to be created at the RS and MS layers as well.

Endpoints D and E will report that auto-discovery data is not reliable—because fibre is missing. Their autodiscovery signatures will be stored in the Trail Manager database but no further action will be taken in this scenario.

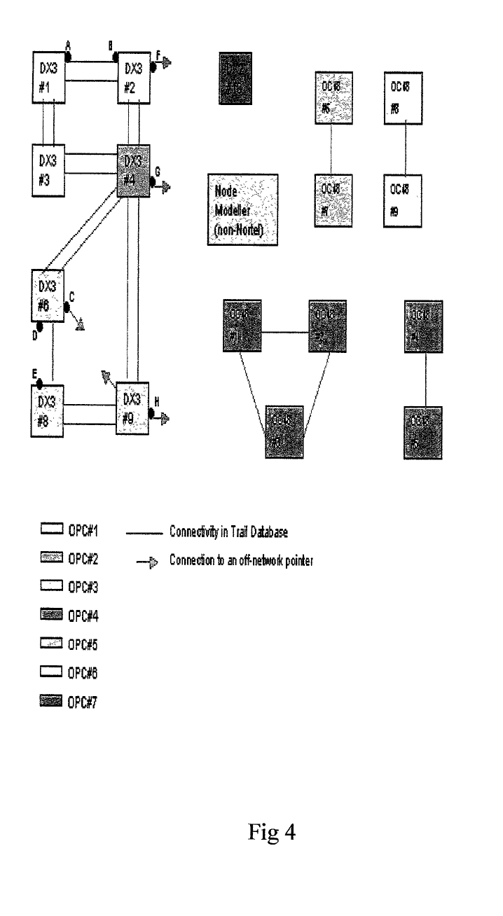

Endpoint C will report that auto-discovery is turned off. It will remain connected to an off-network pointer. The receivers on endpoints F,G and H are connected to NEs that do not support auto-discovery and will report an unreliable auto-discovery signature. Consequently, they will remain connected to an off-network pointer. The transmitters on endpoints F,G and H will report an auto-discovery signature that is not found on any other endpoint, causing them to remain connected to an off-network pointer. When start-up alignment is complete, the database will have the view of the network illustrated in FIG. 4.

In order for the Trail Database to reflect the physical connectivity that is actually in the network, the following actions must be taken:

Use the reconfig tool to cut in the DWDM network in between DX3 #8 and DX3 #9. Create a Ps file to describe the connectivity at endpoints F,G and H and use netbuild (which will use pcm) to delete the off-network trails at endpoints F,G and H and to process the Ps file. Trail Manager will automatically delete off-network trails when building new trails. Turn on auto-discovery on endpoint C or use Netbuild to delete the off-network trail at C and create a Ps file to model the connectivity at that endpoint. Insert fibre between endpoints D and E or create a Ps file to model the connectivity between D and E.

Automatic Management of Physical Connectivity

As previously mentioned, the physical connectivity of the network is described in text files, many of which were hitherto manually generated. These text files are processed, at the request of the user, by the Netbuild tool, which stores the connectivity in the database. Any time the physical connectivity changes in the network, users are required to use a variety of tools to manually update the database. The present invention provides for Automatic Management of Physical Connectivity. When Trail Manager is notified that physical connectivity has been enrolled, deleted or modified, it updates the database to reflect the state of the network. This, however, becomes quite complicated if logical trails exist in the network.

Logical trails are usually built by users that have very specific requirements. If Trail Manager was aware of the requirements that were used to build a trail, and it could modify that trail in a manner such that the trail still satisfied the original requirements, then Trail Manager could automatically make the modifications. If, however, Trail Manager was not capable of modifying the trail so that the original requirements were still satisified, it should not make any modifications.

The requirements used to build a trail will be stored in the trail in the form of a policy. Policies apply to physical and logical trails. They are assigned to trails when they are built from the Trail Manager UI. If a trail is learned from the network, a policy is assigned when the trail is accepted by the user.

Two possible policies are: “Locked” and “Network Adjustable”. A trail with the “Locked” policy cannot be deleted or modified unless a user explicitly indicates that it can be modified or deleted via the Trail Manager UI. Users can delete trails with a “Locked” policy by explicitly deleting them at the Traim Manager UI or by using Netbuild or by accepting a trail that is in conflict with it. Users can modify trails with a “Locked” policy by editing them at the Trail Manager UI. A trail with the “Network Adjustable” policy can be fragmented and even deleted during network reconfigurations. A trail with a “Network Adjustable” policy will enter the “Network Learned” state during a reconfiguration. Because of this, trails with a “Network Adjustable” policy will always reflect the state of the network following a reconfiguration. They must also be accepted following a reconfiguration.

Although a policy may allow a trail to be modified or deleted, if that trail acts as a server to another trail, the modification is only permitted if client trails can still adhere to their policies when the change has taken effect. For example, if the network indicates that “Trail A” has been de-enrolled, Trail Manager can automatically delete “Trail A” if it has a “Network Adjustable” policy. If, however, “Trail A” had a client with a “Locked” policy, “Trail A” could not be deleted because its client cannot be automatically modified and because a trail cannot exist without a server trail (except at the PMS layer).

During a network reconfiguration, if the network reports the existence of a trail, the policies of all affected trails will be used to determine what action to take. This is illustrated in FIG. 5. Similarily, if the network reports that a trail has been deleted, the policies of all affected trails will be used to determine what action to take. This is illustrated in FIG. 6.

In the system according to a preferred embodiment, the action of accepting trails from the Trail Manager UI will be modified to support policies and conflict resolution. The following functionality will be available:

Only Network Learned trails that do not have server trails in the Network Learned state can be accepted. (i.e. users will not be given the option of accepting a Network Learned STS1 trail that has an MS server trail in the Network Learned state. Consequently, only PMS trails can be accepted.)

When a user accepts a trail, a policy will be applied to the trail. This policy will be specified by the user at the Trail Manager UI.

Accepting a must-connect/non-flexible trail causes all trails that were derived from it to be accepted also and to have the policy specified by the user applied to them.

Accepting a logical/flexible trail causes only the specified trail to be accepted.

Accepting a trail that is in conflict with another trail will cause the other trail to be deleted or, if it cannot be deleted, it will enter the “Deleted Supporting” state.

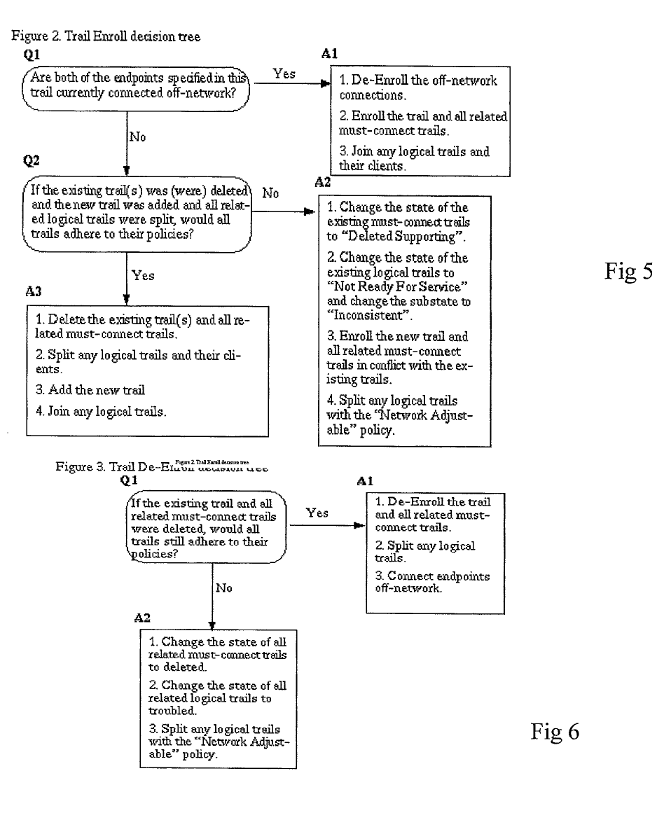

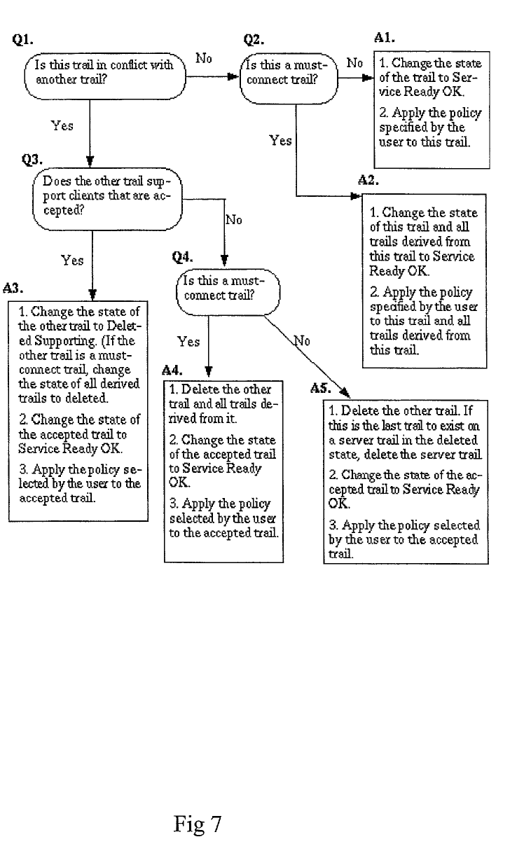

FIG. 7 illustrates the actions that will be taken when a user accepts a trail:

The following example illustrates the decision trees described with reference to FIGS. 5 and 6.

### EXAMPLE 1

Trail Manager performs start-up alignment on a network. During start-up alignment, all endpoints will be connected off-network. Then, during start-up alignment, the MOAs will report a list of trails between its network elements. When Trail Manager receives this list of trails, it realizes that the endpoints specified in the trails are connected off-network—so, it de-enrolls the off-network connection and enrolls the new trails. Since there are no logical trails at this point, no further action is taken.

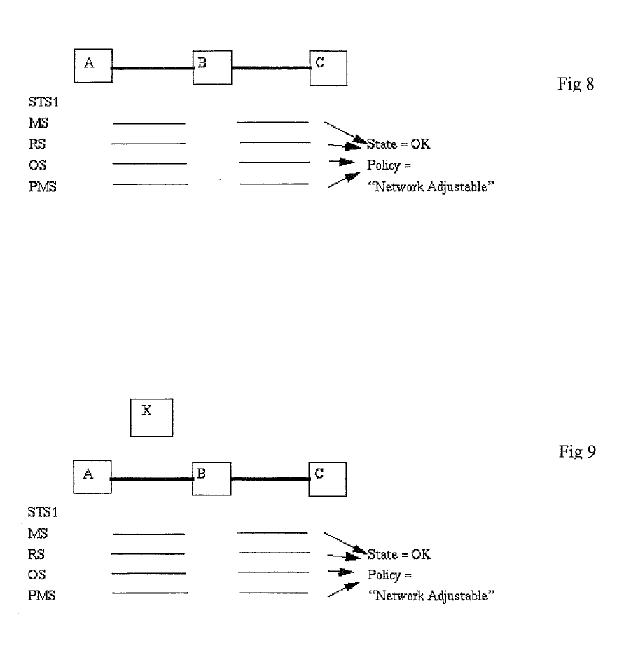

In this example, auto-acceptance is turned off, so all trails that are enrolled are in the network learned state. At this point, no logical trails can be built in this network because all trails are in the network learned state. (Users can only build trails on trails in the “Accepted” state). When the user accepts the network learned trails from the Trail Manager UI, he/she must select a policy for these trails. In this example, assume the user selects the “Network Adjustable” policy. At this point, the network would appear as shown in FIG. 8. If node X is then inserted inbetween nodes A and B, the following events would be received from the network and would appear as in FIG. 9:

trail de-enroll for trail AB

trail enroll for trail AX

trail enroll for trail XB

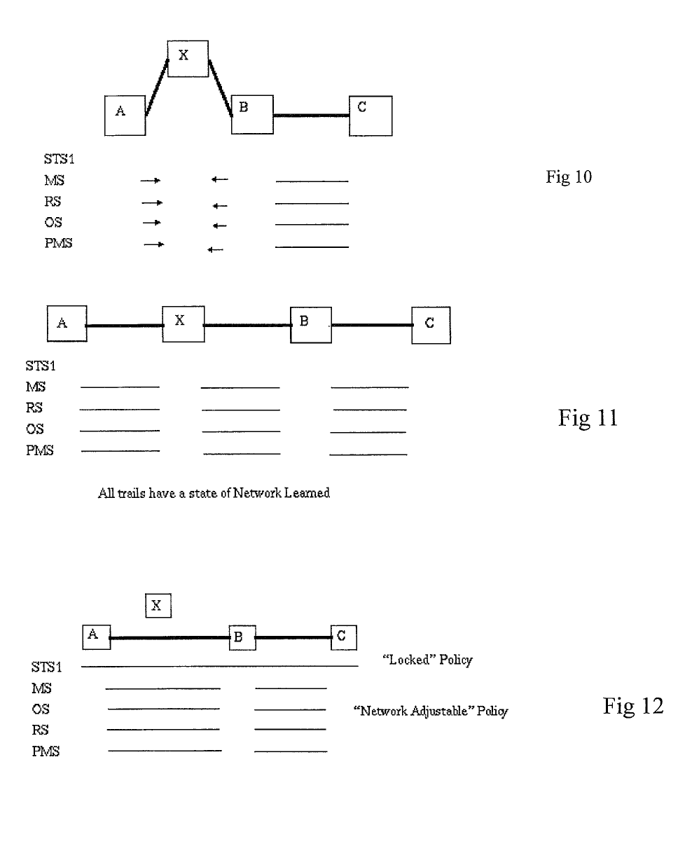

When Trail Manager receives the trail de-enroll message for trail AB, it consults the policies of all trails between A and B. Since all of these trails have the “Network Adjustable” policy, which allows them to be modified or deleted without user intervention, Trail Manager automatically deletes the trails between A and B and connects the endpoints off network. The network would then appear as shown in FIG. 10.

When Trail Manager receives the trail enroll message for AX, it finds that the endpoints are already connected off-network, so it de-enrolls the off-network connections, enrolls the new trails and joins any logical trails (there are none to join in this example). The same actions are taken when the trail enroll message for XB is received. The final state of the network is as shown in FIG. 11.

### EXAMPLE 3

Trail Manager performs start-up alignment on the network and eventually discovers the connectivity of the network and enrolls it in the database. In this example, auto-acceptance is turned off, so all physical trails are in the network learned state. A user, who wishes to build a logical trail on this network, accepts the physical trails from the Trail Manager UI, and in doing so, assigns them the “Network Adjustable” policy. The user then builds a logical trail and assigns it the “Locked” policy. At this point, the network would appear as shown in FIG. 12.

When the physical trail between A and B is de-enrolled, Trail Manager consults the policies of all trails that would be affected by the trail de-enroll and notices that the trail at the STS1 layer cannot be deleted or modified because it has a “Locked” policy. So, instead of deleting the trail, it simply changes the state to deleted. When the network notifies Trail Manager that the trail between A and X is enrolled, Trail Manager consults the policies of all trails that would be affected by the trail enroll, and notices that the trail at the STS1 layer cannot be deleted or modified because it has a “Locked” policy. So, it enrolls trail AX in conflict with trail AB. (At this point, the must connect trails between A & B are already in the deleted state and the logical trails are already in the troubled state.).

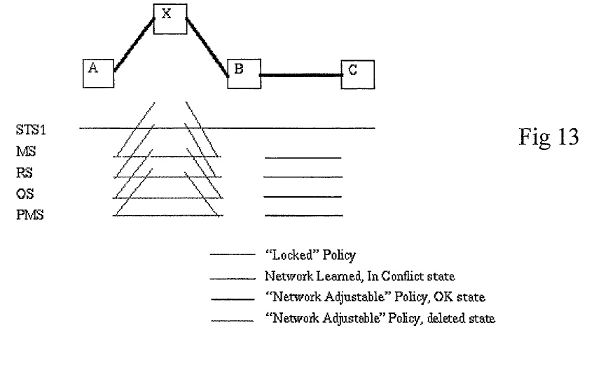

The trail enroll event for the trail between X and B is treated in a similar manner. When all of the events are processed, the trail database would appear as shown in FIG. 13. If node X contained cross connects, trail explorer would learn an STS1 trail (AXBC) that is in conflict with the original STS1 trail (ABC). At this point, users will be given the opportunity to accept the must-connect server trails that are in the Network Learned, In Conflict state. (Although there is an STS1 Network Learned In Conflict trail, users will not be given the option to accept this trail until its servers are accepted.)

Once the user has accepted the must-connect trails, the user will then be given the option to accept the network learned STS1 trail (AXBC). This would cause trail ABC to be deleted. And, since trail ABC is the only logical trail on the trails from A to B which are in the deleted state, the trails from A to B will be automatically deleted as well.

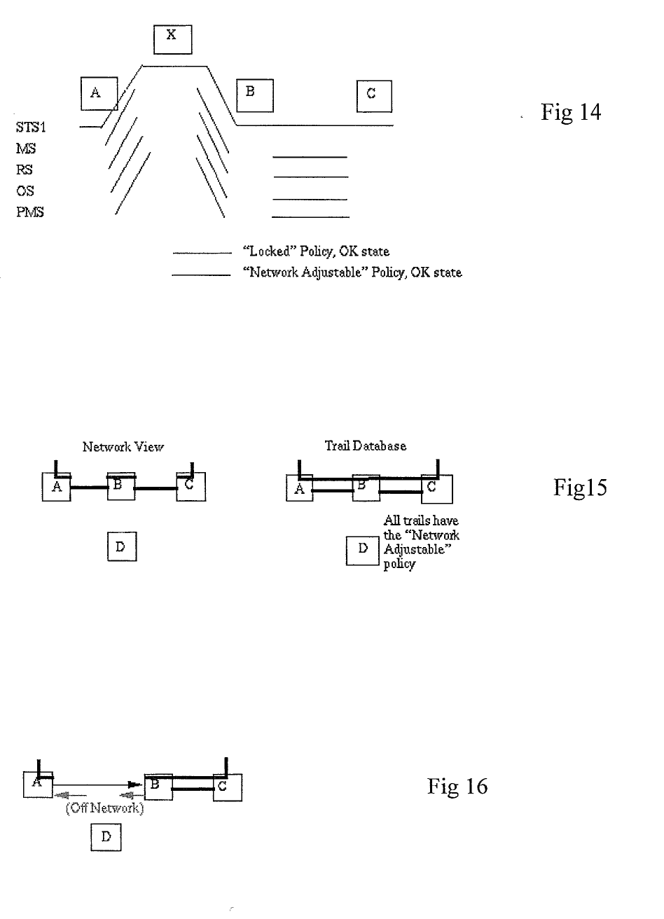

When accepting the STS1 trail, the user would be allowed to select a new policy for the trail. In this example, the user selects the “Locked” policy. The network would then appear as shown in FIG. 14.

If node X did not contain cross connects, the user could edit the trail ABC so that it passes through node X. Since editing the trail moves the trail off of the link between A and B, and since this is the only trail on link AB which is in the deleted state, link AB will be automatically deleted. The network would then appear as shown in the Figure.

### EXAMPLE 4

Trail Manager is assumed to be managing four network elements. FIG. 15 illustrates both the actual state of the network and the Trail Manager database view of the network. When the fibre between A and B is removed, both endpoints A and B will report that their auto-discovery data is unreadable. No action will be taken by Trail Manager. When the fibre is inserted between A and D, the endpoints will report new connectivity. If endpoint A is the first endpoint to report its auto-discovery data, its transmitter will remain connected to B, because that will be the only endpoint where its auto-discovery signature can be found. The receiver will report a new auto-discovery signature that cannot be found on any other endpoint, so Trail Manager will assume that the unidirectional trail from B to A has been de-enrolled. Since all trails from B to A have a “Network Adjustable” policy, the must-connect trails from B to A will be de-enrolled, the logical trail ABC will be split into two trails (A & BC), and the rx on A and the tx on B will be connected off-network. Similar behaviour would be observed if D reported its auto-discvery data first. FIG. 16 represents the database view of the network after auto-discovery data is received from A.

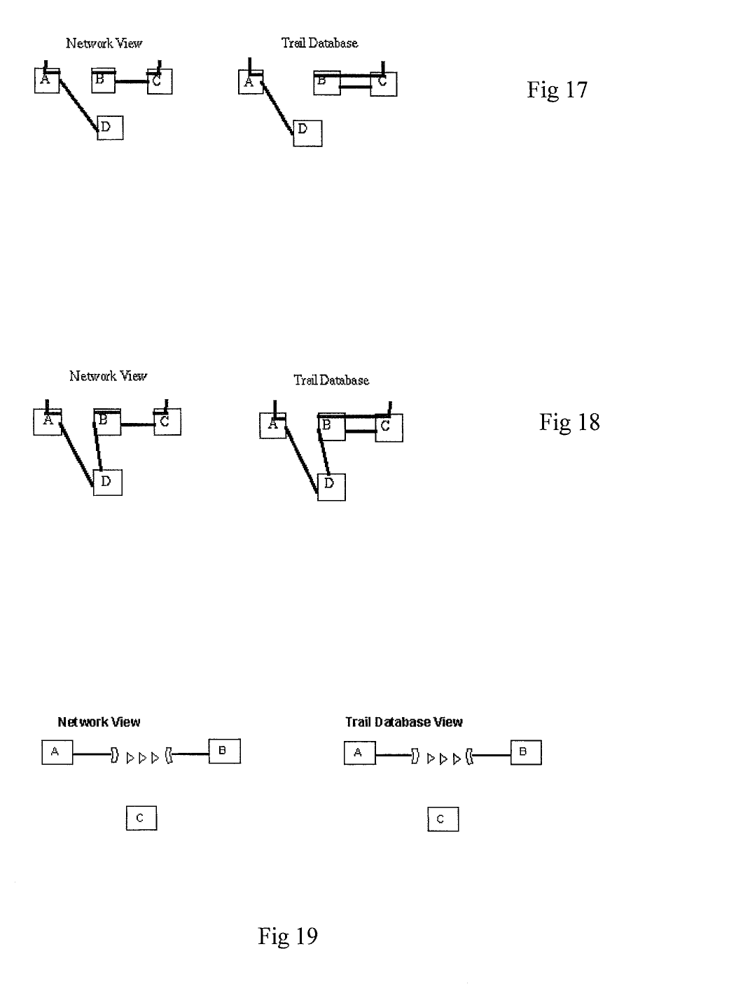

When auto-discovery data is received from the second endpoint, D for instance, its receiver will find its auto-discovery signature on A. Trail Manager will assume that the unidirectional trail from A to B has been de-enrolled. Since all trails have the “Network Adjustable” policy, the must-connect trails from A to B will be deleted and A and B will be connected off-network. Trail Manager will then find the auto-discovery signature of D's receiver on A's transmitter and will assume that D is connected to A. Trail Manager will de-enroll the off-network connections and enroll the trail from A to D. Similarily, when the auto-discovery data from D's transmitter is received, Trail Manager will assume that D is connected to A. The off-network connections will be de-enrolled, the trail from D to A will be enrolled and any logical trails will be joined. FIG. 17 shows the actual state of the network as well as the Trail Manager database view of the network.

If the fibre between B and C is removed, both B and C will report that their auto-discovery data is unreadable. Trail Manager will take no action. When the fibre is inserted between B and D, the endpoints will report new connectivity. Eventually, endpoint B will find its auto-discovery signature on D and vice versa. When this occurs, Trail Manager will assume that trail BD is deleted and it will assume that trail BD is enrolled. Trail Manager will automatically build the trails between B and D. The situation is represented by FIG. 18. If node D did not contain any cross connects, incomplete trail edit could be used to build the cross connect on node D. If node D did contain cross connects, trail explorer would learn the complete logical trail and the user would simply have to accept the new trails.

### EXAMPLE 5

### Reconfigurations When Optical Components are Present

In this scenario, Trail Manager is assumed to be managing three NEs, a pair of DWDM couplers and an amplifier chain. FIG. 19 illustrates the actual state of the network and the Trail Manager database view of the network.

In this example, the connectivity between the couplers, between A and the coupler and between B and the coupler has been built by Netbuild. If C is inserted between A and the coupler, both A, B and C will report new MS layer auto-discovery data. A will find its MS layer auto-discovery signature on C and vice versa and, since no lower layer auto-discovery technique exists, this would cause the trails between A and the coupler and between B and the coupler to be deleted. Similarily, the trail between A and C will be created. C will find its MS layer auto-discovery signature on B and vice versa, causing the trail between B and C to be created. If it was possible to auto-discover the connectivity between ADMs and couplers, the database would be updated appropriately. However, if this functionality is not available, users must use optical cut-ins or the reconfig tool or manual trail split to correct the database.

Interaction with Netbuild

The Netbuild application is currently used to build trails that model physical connectivity between endpoints. When Netbuild creates a trail, it automatically enters the “Service Ready OK” state. Netbuild will not allow trails to be built when the endpoints are used in another trail. Netbuild will not allow trails to be deleted when they support logical trails. Netbuild can also be used to delete trails from the database without deleting them from the network. In order to be fully compatible with autodiscovery, Netbuild has the same behaviour as auto-discovery. In particular Netbuild must: apply a policy specified by the user to all trails that it creates; must be capable of building trails in a manner that allows all trails to still adhere to their policies; must be capable of deleting trails in a manner that allows all trails to still adhere to their policies; must be capable of printing out trails that are in conflict; and must be capable of reverse engineering the trail database when trails are in conflict.

Endpoint Cutovers

Endpoint cutovers are performed to resolve conflicts between endpoints. Endpoints may become in conflict following an MOA upgrade because endpoint templates typically change as a result of an upgrade. Endpoint cutovers are performed by a script that can be executed from the UNIX command line. The endpoint cutover script behaves differently depending on the type of endpoint cutover. For compatible endpoint cutovers, the script will enroll the new endpoint and cutover the existing trails to the new endpoint. The existing trails are not deleted for compatible endpoint cutovers. The trail core process can automatically handle compatible endpoint cutovers without requiring users to invoke the endpoint cutover script. The trail core will not delete any existing trails when performing the compatible endpoint cutover.

For incompatible endpoint cutovers, the script will execute the following steps:

The database is reverse engineered to create Ps files

All trails are removed from the endpoint

The endpoint conflict is resolved

Netbuild processes the Ps files and reapplies the trails

Logical trails are relearned

It is possible that following an incompatible endpoint cutover, the physical connectivity in the database may not reflect the connectivity that was originally in the database prior to the cutover. For example, if the pre-endpoint-cutover database contained trails in-conflict, the post-endpoint-cutover database will not. This is because Netbuild does not allow trails to be built in conflict. Other techniques for performing certain types of cutover are the subject of our copending U.S. patent application Ser. No. 09/882925. This problem could also be solved by modifying the endpoint cutover script to use the “auto-discovery Netbuild option” previously described.

Multiple Auto-Discovery Techniques

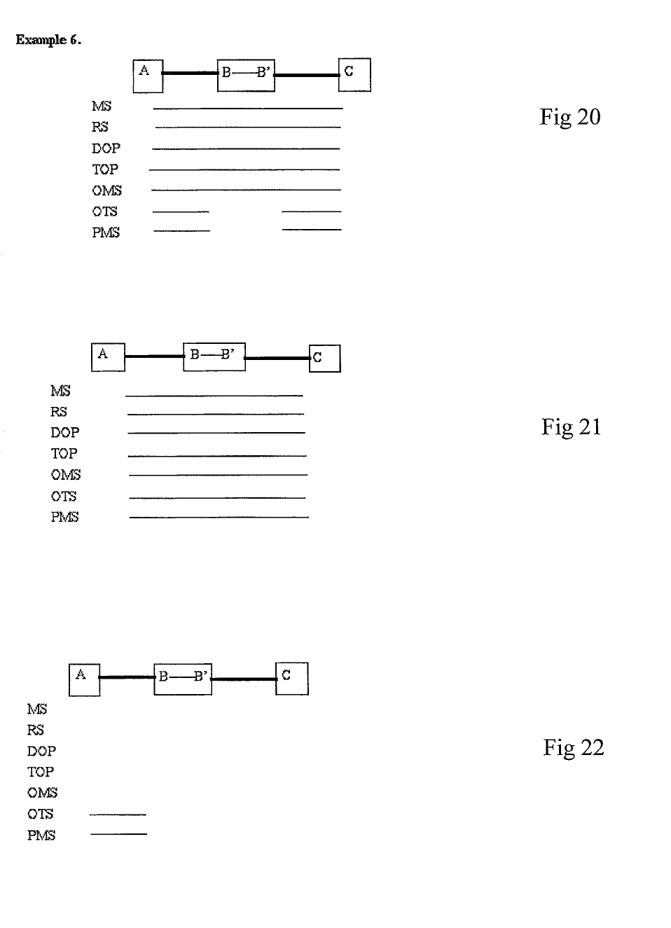

Auto-discovery is also capable of supporting multiple auto-discovery techniques on the same endpoint. For instance, in the network represented by FIG. 20, Endpoint A can provide an auto-discovery signature that can be found on Endpoint C at the MS layer and Endpoint A can provide an autodiscovery signature that can be found on Endpoint B at the OTS layer.

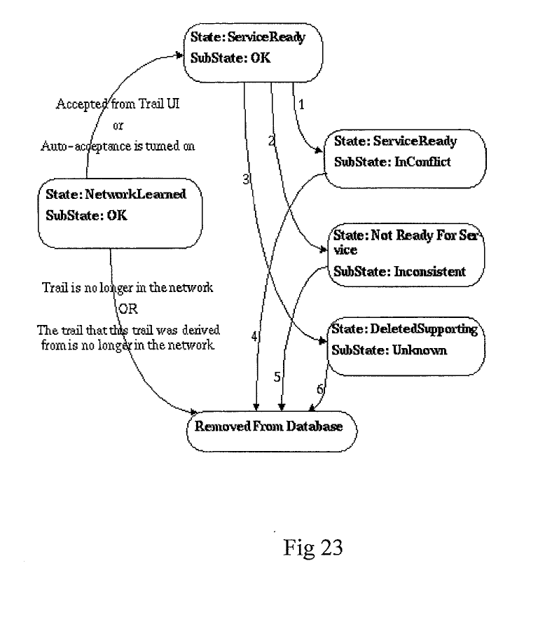

Since lower layer autodiscovery techniques are more accurate than higher layer autodiscovery techniques, lower layer techniques will take precedence. So, if endpoint A reports an auto-discovery signature at the MS layer that can be found on endpoint C at the MS layer, auto-discovery would build the connectivity represented by FIG. 21. If endpoint A then reported an auto-discovery signature at the OTS layer that can be found on endpoint B at the OTS layer, auto-discovery would delete the A-C trails and attempt to build the OTS layer trail because it is more accurate than the MS trail. If Endpoints A and B were the only trails to report OTS layer autodiscovery signatures, the connectivity represented by FIG. 22 would be built. Similarily, if endpoint A reported an autodiscovery signature at the OTS layer first, auto-discovery would build the OTS layer trail. Then, when Endpoint A reports its MS layer autodiscovery signature, autodiscovery would notice that a lower layer autodiscovery technique exists on at least one of the endpoints and would not attempt to build anything.

Opting Out of Auto-Apply

Although autodiscovery should, in theory, support all network element types, there will be some network elements that need to opt out of automatically applying all trails that they report. Since the autodiscovery on/off switch is a network-wide switch, it would not be acceptable to disable autodiscovery on the entire network, just to prevent some network elements from having their trails automatically applied. A solution that works on a per trail basis is necessary. If an MOA does not want a trail to be automatically applied to the trail database—regardless of the state of the autodiscovery switch—it reports a TPAM attribute called “Auto-Apply” with a value set to false. There are two ways to report this attribute value:

(1) For complete trails, this TPAM attribute value can be reported in the trail_info structure's tp_sub_type_list. This would not require any template changes. This is illustrated below:

struct xdr_tmcom_trail_info {

xdr_tmcom_trail_points trail_points = }

u_short first_ne = 4817;
xdr_tmcom_universal_location first_endpoint = {

u_char shelf = 0;
u_char sub_shelf = 0;
u_char slot = 7;
u_char sub_slot = 0;
u_char port_number = 1;
u_short endpoint_instance = 0;
struct {

u_int payload_index_len = 0;
u_short *payload_index_val = NULL;

} payload_index
xdr_tmcom_tp_class tp_class = xdr_tmcom_ctp_tp_class;
xdr_tmcom_tp_details tp_details = {

xdr_tmcom_tp_type tp_type = xdr_tmcom_MS;
xdr_tmcom_tp_type_qualifier tp_qualifier =

xdr_tmcom_STM64;

struct }

u_int tp_sub_type_list_len = 0;
xdr_tmcom_tp_sub_type_list_val = NULL;

} ;

xdr_tmcom_directionality direction =

xdr_tmcom_bidirectional;

} ;

u_short second_ne = 4818;
xdr_tmcom_universal_location second_endpoint = {

u_char shelf = 0;
u_char sub_shelf = 0;
u_char slot = 8;
u_char sub_slot = 0;
u_char port_number = 1;
u_short endpoint_instance = 0;
struct {

u_int payload_index_len = 0;
u_short *payload_index_val = NULL;

} payload_index;
xdr_tmcom_tp_class tp_class = xdr_tmcom_ctp_tp_class;
xdr_tmcom_tp_details tp_details = {

xdr_tmcom_tp_type tp_type = xdr_tmcom_MS;
xdr_tmcom_tp_type_qualifier tp_qualifier =

xdr_tmcom_STM64;

struct {

u_int tp_sub_type_list_len = 0;
xdr_tmcom_tp_sub_type *tp_sub_type_list_val
= NULL;

} tp_sub_type_list;

} ;
xdr_tmcom_directionality direction =

xdr_tmcorn_bidirectional;

};

};
char *user_label = “ ” ;
char *customer_label = “ ” ;
xdr_tmcom_tp_details ttp_type = {

xdr_tmcom_tp_type = xdr_tmcom_ctp_tp_class;
xdr_tmcom_tp_qualifier =
struct {

u_int tp_sub_type_list_len = 1;
xdr_tmcom_tp_sub_type [0] {

xdr_tmcom_tp_sub_type_name = “Auto-Apply”;
xdr_tmcom_tp_subtype_value = “ FALSE”;
xdr_tmcom_tp_sub_type_null_equals = “ ”;
end_to_end_match = xdr_tmcom_no_match_required;

}

xdr_tmcom_simple_control trail_adjustment_prevented = xdr_tmcom_on;
xdr_tmcom_directionality directionality = xdr_tmcom_bidirectional;
} ;

Prior to enrolling any trail, autodiscovery will check for the presence of the auto-apply attribute in the trail_info->ttp_type structure. If it finds an “Auto-Apply” attribute with a value of FALSE, the trail will not be automatically applied.

(2) For trails that require correlation, the TPAM attribute is reported in the tp_sub_type in the universal location that is filled in. This is illustrated below.

struct xdr_tmcom_trail_info {

xdr_tmcom_trail_points trail_points = }

u_short first_ne = 4817;
xdr_tmcorn_universal_location first_endpoint = {

u_char shelf = 0;
u_char sub_shelf = 0;
u_char slot = 7;
u_char sub_slot = 0;
u_char port_number = 1;
u_short endpoint_instance = 0;
struct {

u_int payload_index_len = 0;
u_short *payload_index_val = NULL;

} payload_index;
xdr_tmcom_tp_class tp_class = xdr_tmcom_ctp_tp_class;
xdr_tmcom_tp_details tp_details = {

xdr_tmcom_tp_type tp_type = xdr_tmcom_MS;
xdr_tmcom_tp_type_qualifier tp_qualifier =
xdr_tmcom_STM64;

struct {

u_int tp_sub_type_list_len = 4;
xdr_tmcom_tp_sub_type_list_val [0]=

char* tp_sub_type_name =

“ ?R=$S:AutodiscoveryEnabled”

char* tp_sub_type_value = “ TRUE” ;

xdr_tmcom_tp_sub_type_list_val[l] =

char* tp_sub_type_name

“ ?R=$S:AutodiscoveryReadable”

char* tp_sub_type_value = “TRUE”

xdr_tmcom_tp_sub_type_list_val[2] =

char* tp_sub_type_name =

“ ?R=$S” AutodiscoverySignatureTx”

char* tp_sub_type_value =

“ MACAddress:0:0:7:0:1”

xdr_tmcom_tp_sub_type_list_val [3]

char* tp_sub_type_name = “ ?R=$S:Auto-Apply”
char* tp_sub_type_value = “FALSE”

} tp_sub_type_list;

} ;

xdr_tmcom_directionality direction =

xdr_tmcom_bidirectional;

} ;

u_short second_ne = 0;
xdr_tmcom_universal_location second_endpoint = {

u_char shelf = 0;
u_char sub_shelf = 0;
u_char slot = 0;
u_char sub_slot = 0;
u_char port_number = 0;
u_short endpoint_instance = 0;
struct }

u_int payload_index_len = 0;
u_short *payload_index_val = NULL;

} payload_index;
xdr_tmcom_tp_class tp_class = xdr_tmcom_null_tp_class;
xdr_tmcom_tp_details tp_details =

xdrtmcomtp type tptype = xdr_tmcom_null_tp_type;
xdr_tmcom_tp_type_qualitier tp_qualifier =

xdr_tmcom_null_qualifier;

struct {

u_int tp_sub_type_list_len;
xdr_tmcom_tp_sub_type *tp_sub_type_list_val
= NULL;

} tp_sub_type_list;

} ;
xdr_tmcom_directionality direction =

xdr_tmcom_unidirectional;

} ;

} ;
char *user_label = “ ”;
char *customer_label = “ ”;
xdr_tmcom_tp_details ttp_type = xdr_tmcom_ctp_tp_class;
xdr_tmcom_simple_control trail_adjustment_prevented = xdr_tmcom_on;
xdr_tmcom_directionality directionality = xdr_tmcom_bidirectional;
} ;

If an MOA plans to report the Auto-Apply TPAM attribute value in the universal location, the templates must be modified to reflect this. The following TPAM attribute definition must be added:

struct xdr_tmcom_tp_sub_type {

char *tp_sub_type_name = ″ !D=Aauto-Apply″ ;
char *tp_sub_type_value = ″ !T=$E:TRUE,FALSE; !S=trl″ ;

char *tp_sub_type_null_equals = NULL;
xdr_tmcom_tp_match_enforce = end_to_end_match;

} ;

Auto-apply attribute values that are reported in universal locations will be stored in the trail database. Prior to enrolling any trail, autodiscovery will retrieve the termination point's attributes. If it finds an auto-apply attribute with a value of FALSE, it will not enroll the trail. It is to be noted that if an MOA reports an auto-apply attribute value in a universal location in the xdr_tmcom_trail_info structure, this attribute value will be stored in the trail database. If the MOA then wishes to turn Auto-Apply on, they must report the new attribute value in the universal location in the xdr_tmcom_trail_info structure so that the database can be updated with the new value. Failure to do so will result in auto-apply remaining set to FALSE and no trails being enrolled in the database. Also, if an MOA does not report an Auto-Apply attribute and has never done so, its trails will be automatically applied.

Unidirectional and Bidirectional Endpoints

In networks where all 2.5 Gb/s and 10.0 Gb/s facilities are modelled with two endpoints, a unidirectional endpoint and a bidirectional endpoint. Autodiscovery must intelligently select which endpoint to use. Since the “wave-id” autodiscovery technique and the “stolen-bytes in line overhead” technique can both exist on endpoints and since wave-id can only exist on unidirectional endpoints, autodiscovery will try to use unidirectional endpoints wherever possible.

If “autodiscovery WITH network change” is enabled, autodiscovery will have the following behaviour:

if a trail-enroll notification is received and the endpoints specified in the notification are not in use, autodiscovery will build the trail on the unidirectional endpoints—if unidirectional endpoints exist;

if a trail enroll notification is received and the trail already exists in the database—but exists on the bidirectional endpoints—autodiscovery will rebuild the trails on the unidirectional endpoints;

if a trail enroll notification is received and one of the endpoints specified in the notification is in use in a different trail and it is a bidirectional endpoint, that trail will be deleted. The new trail will be added using the unidirectional endpoints. All logical trails will be automatically cut over from the bidirectional endpoint to the unidirectional endpoint.

If “autodiscovery WITHOUT network change” is enabled, autodiscovery will have the following behaviour:

if a trail enroll notification is received and the endpoints specified in the notification are not in use, autodiscovery will build the trail on the unidirectional endpoints—if unidirectional endpoints exist;

if a trail enroll notification is received and the trail already exists in the database—but exists on the bidirectional endpoints—autodiscovery will take no action. A log entry will be generated. A Ps file will also be created. The Ps file will use the unidirectional endpoints.

If autodiscovery is disabled, autodiscovery will create Ps files using the unidirectional endpoints—if they exist.

Autodiscovery Modes

Autodiscovery will support the following three modes of operation:

autodiscovery disabled

autodiscovery enabled without network change

autodiscovery enabled with network change

When autodiscovery is disabled, autodiscovery will not automatically update the database in any way. When auto-discovery is enabled WITHOUT network change, autodiscovery will only enroll trails if the endpoints are not in use by any other trail. When autodiscovery is enabled WITH network change, autodiscovery will automatically modify, delete and enroll trails according to information provided by the network.

Autodiscovery Logging

Autodiscovery will use the logging functionality that currently exists in Trail Manager. An autodiscovery log will be created in /opt/nortel/logs. The location of the log file can be modified by modifying the LOG_DIRECTORY parameter in the /opt/nortel/tm/errorcnf.log file. All log entries will be date-stamped. Every message reported by the network (except autodiscovery signatures) will be logged with one of a predetermined set of log entries:

Network reports the following trail exists:

Network reports the following trail has been de-enrolled:

Network reports the following trail has been enrolled:

After each of these log messages, there will be log entries that describe the actions taken for that event. The following list details possible log entries:

Derived that the following trail should be removed:

No action taken on trail

Autodiscovery is disabled.

No action taken. Trail already exists.

No action taken. Network Change is disabled. Conflict found.

No action taken. Auto-apply is turned off for this trail.

No action taken. Non-splittable trails are supported by this trail.

Split logical trail

Could not split logical trails on

Removed trails on first endpoint in trail

Removed trails on second endpoint in trail

Successfully enrolled trail:

Removed trail:

Some sample excerpts from an autodiscovery log are reproduced below. If the network reports a trail, and the trail has been successfully enrolled, the log would contain entries similiar to the following:

Network reports the following trail exists:

Successfully enrolled trail:

If the network reports a trail, and the trail already exists in the database, the log would contain entries similar to the following:

Network reports the following trail exists:

No action taken. Trail already exists

If the network reports a trail de-enrol notification, the log would contain entries similar to the following:

Network reports the following trail has been de-enrolled:

Removed trail:

If the network reports an autodiscovery signature that allows autodiscovery to deduce the existence of a trail, the log would contain entries similar to the following:

Autodiscovery derived that the following trail exists:

Successfully enrolled trail:

Ps File Generation and Maintenance

All Ps files will be generated by the autodiscovery process. If autodiscovery is disabled, Ps files will be generated for all messages received from the network. If autodiscovery is enabled WITHOUT network change, Ps files will be generated under the following circumstances:

the network reports a trail with the auto-apply flag set to false

one of the endpoints used in the trail is used in a different trail

If autodiscovery is enabled WITH network change, Ps files will be generated under the following circumstances:

the network reports a trail with the auto-apply flag set to false

the network reports a trail and at least one of the endpoints used in the trail support non-splittable logical trails (i.e. scheduled trails, NotReadyForService trails or an unsupported trail shape)

Each MOA may have two Ps files per layer per session—one for greenfield discovery details and one for conflicts. For instance, a MOA may have the following Ps files:

an MS layer Ps file containing connectivity found during startup alignment or a resync—if the endpoints are not already used in a trail (greenfield file)

an MS layer Ps file containing connectivity found during startup alignment or a resync that does not already exist in the database and where at least one endpoint is used in other trails (manual file).

an OTS layer Ps file containing the connectivity found during startup alignment or a resync—if the endpoints are not already used in a trail (greenfield file)

an OTS layer Ps file containing the connectivity found during startup alignment or a resync that does not already exist in the database and where at least one endpoint is used in other trails (manual file).

In addition to this, there will be one Ps file—called a network flux file—per layer per day. The network flux files will contain any asynchronous trail enroll and de-enroll notifications received from the network, any inter-span trails and any trails that are derived to be de-enrolled. If an asynchronous trail de-enroll event was received and no logical trails exist, the Ps file entry would contain a “D”. If an asynchronous trail de-enroll event was received and logical trails exist, the Ps file entry would contain an “S”. The “S” suggests that the user should use the manual trail split functionality that will be available through Netbuild.

The Reason text in the Ps files could be one of the following:

Inter-span trail.

Received asynchronous trail de-enroll event. Autodiscovery disabled.

Received asynchronous trail enroll event. Autodiscovery disabled.

Derived that the following trail should be de-enrolled. Autodiscovery disabled.

Received asynchronous trail enroll event. MOA does not support auto-apply on this trail.

Received asynchronous trail de-enroll event. MOA does not support auto-apply on this trail.

Derived that the following trail should be de-enrolled. MOA does not support auto-apply on this trail.

Received asynchronous trail de-enroll event. Network change disabled.

Received asynchronous trail enroll event. Network change disabled.

Derived that the following trail should be de-enrolled. Network change disabled.

Derived that the following trail should be de-enrolled. Could not split logical trails.

None of these Ps files will be compressed or deleted.

Preserving User Entered Data

When accepting a network learned trail that is in conflict with another trail, user-entered data is copied from the existing trail to the network learned trail. User-entered data must also be preserved when two network learned trails and a cross connect on a newly inserted node are assembled by trail explorer. This requirement arises because users may have entered data into a trail with a Network Adjustable policy. This data will then become part of a network learned trail during a reconfiguration. When a non-flexible trail with a network adjustable policy is replaced with a network learned trail, user entered data must be copied from the existing trail to the network learned trail.

Trail State Machine

A representation of the Trail State Machine is illustrated in FIG. 23. The following options are represented in FIG. 23 by the reference numbers 1-6 as follows:

1. A trail enroll event was received that uses an endpoint from this trail and trail policy is preventing this trail from being deleted.

2. A server trail to this trail has entered the DeletedSupporting state or the NotReadyForService-Inconsistent state.

3. A trail de-enroll event was received, but the trail cannot be deleted because trail policy would be violated.

OR

A trail de-enroll event was received for a client trail, but the trail cannot be deleted because trail policy would be violated.

4. The Network Learned trail that is in conflict with this trail was accepted.

OR

The trail was explicitly deleted from the Trail UI or Netbuild.

5. The trail was explicitly deleted from the Trail UI or Netbuild.

6. All client trails have been deleted or edited so that this trail no longer has any clients.

OR

A trail enroll event has been received that uses an endpoint from this trail and trail policy allows this trail to be replaced with the new trail.

Looking at the invention from another approach, the relevant information needed to derive connectivity is itself derived by invoking auto-discovery. As previously discussed, Auto-discovery is a technique/application requiring each endpoint or port of a network to self-describe its capability, ie its traffic carrying capability. This information can be made available to the network manager automatically or by interrogation. As already explained, the latter can be effected by injecting a unique signature or trace signal at one port (the transmit port) that is recognisable to the auto-discovery application, retrieving the signature or trace signal at another port (the receive port), reporting the value of the received signature or trace signal to the auto-discovery application, and correlating the sent and retrieved signature or trace signals so as to enable the auto-discovery application to determine the network connectivity.

The auto-discovered information at a lower layer can then be utilised, in conjunction with additional network information, to determine/predict/infer connectivity in a different layer.

This application of the invention will now be described with reference to the remaining Figures of the drawing.

Network Topology Auto-Discovery deals with determining the physical connectivity at various layers in the network (optical, section, line etc). It provides a philosophy for auto-discovering the various layers and interlayer relationships.

As previously mentioned in the introduction, the process of auto-discovery involves the general mechanism as follows:

At the transmit end, inject a unique trace signal that is known to the auto-discover application;

At the receive end, report the value of the received trace signal to the auto-discovery application;

By correlating sent and received trace signals, the auto-discover application can determine network connectivity.

Auto-discovery can be performed either:

at each logical layer to determine the network topology at that layer. For example, by injecting a trace signal at the section layer this could yield the section layer network topology; or a particular layer can be derived by using the auto-discovered information at a lower layer and additional network information—for example, the line layer network topology—can be easily derived from the section layer network topology with information as to which NEs are regenerators.

Inferring one layer based on the auto-discovered connectivity at another layer would involve making use of ‘NE type’ knowledge, impacting on the maintainability of any management system software and would require NE and Network software to be in release lock step. For example, knowledge of connectivity at the Regenerator Section (RS) layer cannot be used to derive connectivity at the Multiplex Section (MS) layer (or any higher layer) without making use of ‘NE Type’ knowledge.

In this context, ‘NE Type’ information refers to management system knowledge that there is a relationship between the MS layer and RS layer. For example, in a Regenerator, ‘NE Type’ might indicate that an MS is carried across two RS terminating ports. ‘NE Type’ information also implies that some specific NE types can provide additional MS layer information, and by using this information some interlayer relationships can be derived. Self-description is one mechanism that can be exploited to dispense with the ‘NE Type’ problem mentioned above by describing the layers supported by a NE on a per port basis (since ports will support auto-discovery capability). It can also serve to determine if and how an NE supports auto-discovery. In addition, certain products will support a TL1 messages that will generically describe interlayer relationships, as it is possible in some scenarios for these relationships to be runtime determinable, for example, configuring an Optera LH 5000 Terminal quadrant as either a Regenerator or 4:1 lambda converter. Utilising the terminating or observing model described below, it is possible for NEs to describe relationships to layers that are not terminated but are visible, i.e. NE has knowledge of the layers

Auto-discovery can be performed at the lowest supported network layer, with higher-level layers being deduced using the auto-discovered connectivity at the lowest layer and the interlayer relationship information provided by the NE. For example, if a Regenerator reports observed RS on port X, sent RS on port Y and indicates that both ports carry a common (but unknown at the Regen section) MS then an application could deduce the Multiplex section. Although the Regenerator configuration is not terminating the MS layer it will be capable of observing auto-discovery tags transported within the MS layer. This further simplifies deduction of the MS layer by RS terminating equipment.

Although this implies that topology derivation will always occur from the lowest layer, this is oily true if attempting to derive the complete network topology. However, with partial topology this may not succeed. For example, consider an Optera LH 1600 G amplifier on some ports and a LH 5000 on others. In one case the lowest layer is optical but in the other it is probably MS. However, if each segment is implemented on a port basis this may not be an issue.

The NE should report information for all the layers that it can observe on each port i.e. if it has MS, RS and OCH trace termination then it should provide the layer relationship within the port to allow for the case of multiple signals (at the same layer) on a single port. The NE should also report the port-to-port relationships (i.e. the Regen example described above).

There are three types of topology data:

(1) Received/Sent/Observed trace

(2) Intra port layer relationships

(3) Inter Port relationships

Self-description will not be used for relationships that are run-time determinable since topology applications may have to go to different places to get the information. Instead, it may be preferable to put it in the “topology” message. During the NE Discovery process the NE would describe the layers it supports via self-description and the EMS would retrieve both the interlayer relationships and the lowest layer next neighbour information via TL1 commands. The EMS Topology Service will then correlate this infonnation to build a directed graph of the various layers in the network.

Next neighbour information should be made available as observed (rather than terminated) at nodes where the layer is not terminated but is observable. NEs should report what is received and the network application can, with knowledge of the network configuration, then decide how to use the information. Also the received trace represents the location of the neighbour in the layer (not the physically adjacent NE). Another reason for reporting observable points is one of evolution. Report all that can be now and as new equipment is added that also reports all it can, network OAM applications will become more powerful.

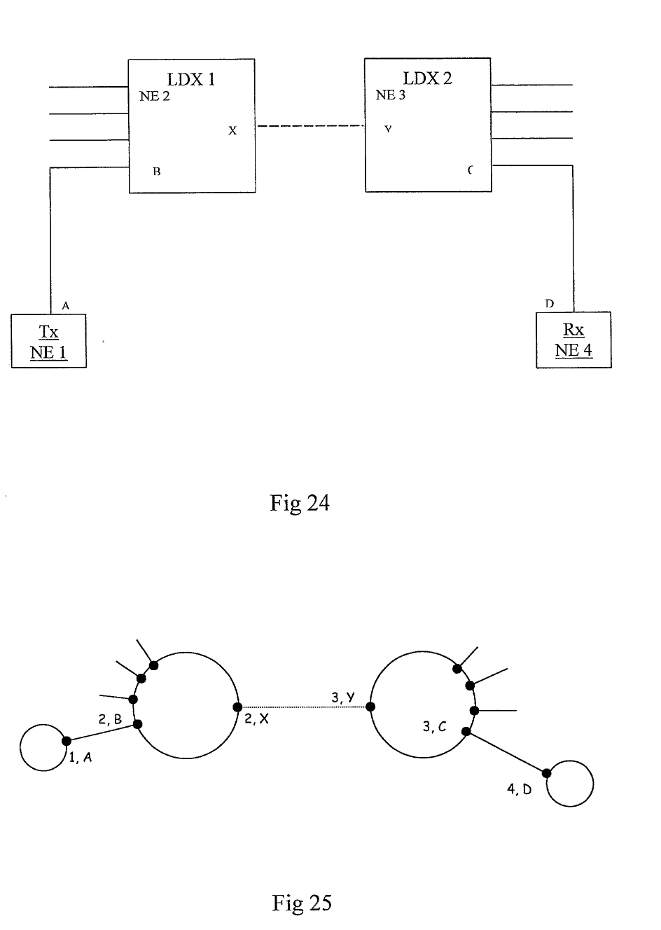

In the following example, with reference to FIG. 24, MS overhead from NE1 is transparently passed through to NE4 (and from NE4 to NE 1) allowing the management system to deduce the link at that layer. The 40 G link between NE2 and NE 3 can also be determined since a trace will be injected and terminated at either end (i.e. from NE2 to NE3—injected at X & terminated at Y; from NE3 to NE2—injected at Y & terminated at X). Also, the next neighbour information at NE2, B and NE3, C can be observed and made available to the EMS level application. All this information will allow network applications to construct the topology at both layers.

Certain assumptions may need to be made in this example. For example:

The transparency at NE2 is such that the section layer can be peeked but the line layer cannot.

Neither the section nor the line layer is terminated at NE2, port X.

The peekability properties of NE2 may not be physically what is possible for LH5000 T, however the purpose below is to illustrate the layered view.

The following illustrates four different layers. The first is the physical or fibre layer, the next is the ‘λ’ layer (which happens to look the same as the physical layer in this example), next is the section and finally the line.

The notation used in FIGS. 20-26 is as follows:

Terminated points are displayed in the layer with a solid (black filled) circle.

Unfilled (white filled) circles for peeked points

Dotted lines to indicate a part of the network that has not been filled out. (In a real network there would likely be multiplexers, amplifiers and demultiplexers between NE2 and NE3.)

The Physical layer illustrated schematically in FIG. 25, shows termination points as being labelled according to the scheme—‘NE ID, port’. Thus, reference 4, D indicates NE number 4, port D.

The ‘λ’ layer (not shown) is very similar since in this system all fibres only carry one ‘λ’ and each ‘λ’ is terminated at each fibre. The only difference is that the arcs would be directed, compared to FIG. 24, where all arcs are directed from left to right.

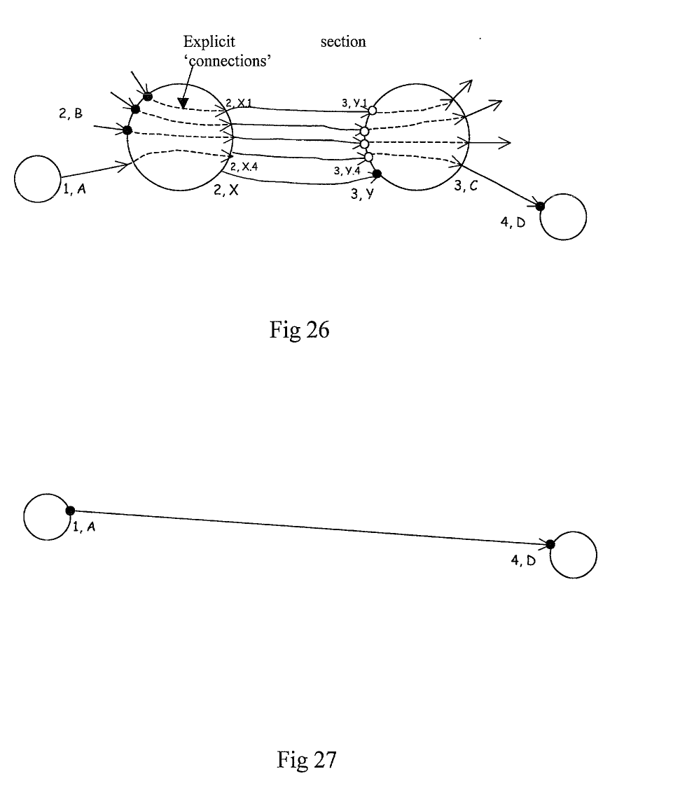

The SONET section layer is illustrated in FIG. 26. The Figure represents a situation where four SONET sections are being carried transparently in another SONET section. The SONET section from 2, X to 3, Y is portrayed as a SONET section, even though the overhead is very unlike SONET since the other SONET section overheads have been packed into it so they can be carried transparently. Strictly speaking this SONET section should be modelled as a separate layer distinct from the regular SONET section layer but, for the sake of simplicity in this particular part of the description, it has been portrayed as shown. The labelling 2, X.1 . . . , 2, X.4 is simply indicating the multiplexing of the four true SONET sections. Ports in this diagram are not physical ports but represent SONET sections. The explicit connections simply show how the SONET sections have been multiplexed.

With reference to FIG. 27, The SONET line layer is comparatively straightforward. The Network Elements NE2 and NE3 do not appear at this layer because the SONET line is unpeekable at these NEs.

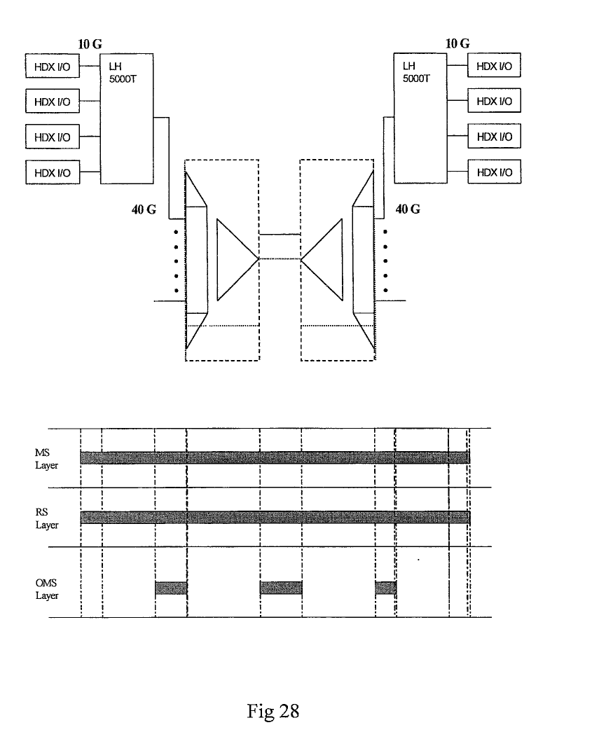

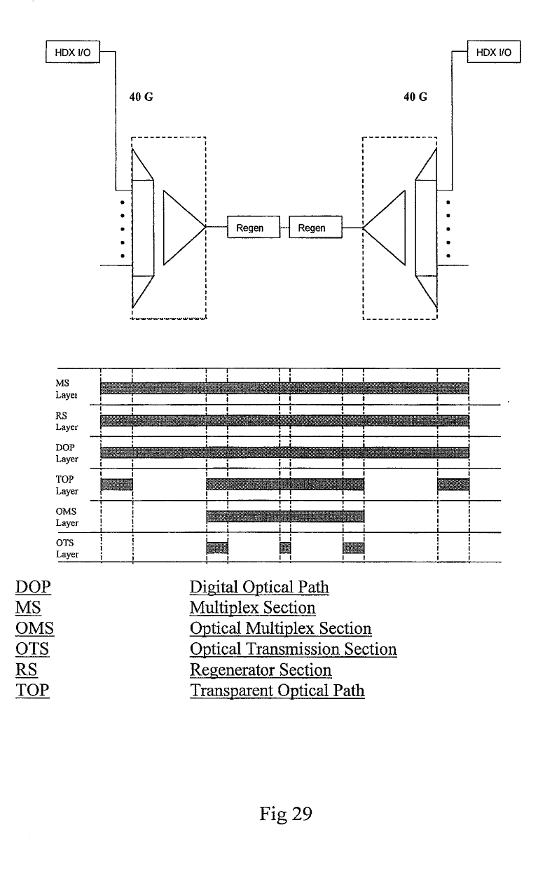

A software program known as the Optera LH 5000 Amplifier program can be used to model topology at two different network layers, namely optical channel (i.e. λ) and fiber layers (physical connectivity at the fiber layer). This is another reason for having explicit interlayer relationship information. Also, the GOC needs “processed topology”, not observed next neighbour. The physical connectivity will be derived from the OSC adjacency based on the physical implementation of the LH 5000 Amplifier, i.e. hard connection to the OSC add/drop filter. FIGS. 28 and 29 illustrate the various layers and interlayer relationships that need to be considered for the Optera LH 5000 Amplifier program. Other layers may need to be added at a later stage.

There are a number of optical layers which may also require modelling, for example support for passive devices, Optical Add-Drop Muxs, mid-stage components and as well as “nodal” topology like components are probably also required.

Network Elements that support auto-discovery will supply the following information on a per Port basis. Since the ability to have multiple layers present on a port will be supported, the information will be modelled as a set of layers on each port. This is the Rx message content. The Tx message content will be added at a later stage.

Set of Sequence {

Layer

Auto-discovery enabled? TRUE/FALSE

Auto-discovery readable? TRUE/FALSE

Auto-discovery technique (i.e. version)

Auto-discovery signature (i.e. the unique signature that is received)

“Peek/terminated” flag

}

The Auto-Discovery Enabled attribute will indicate whether or not auto-discovery is turned on at a facility. If the attribute has a value of TRUE, it will be assumed that the facility has auto-discovery enabled. It the attribute has a value of FALSE, it will be assumed that the facility has auto-discovery disabled.

The Auto-Discovery Readable attribute will indicate whether or not it is possible to read the auto-discovery data. If the attribute has a value of FALSE, it will be assumed that there is no signal or byte-stream from which to read the auto-discovery data—due to a fibre cut or missing fibre, for example. If the attribute has a value of TRUE, it will be assumed that the signal or byte-stream from which to read the auto-discovery data is present.

The Layer attribute will be used to determine the layer at which two entites are physically connected.

(Once the topology service has determined that two termination points are connected at a given layer, it is possible to determine the links that exist at other layers. It may also be necessary to include rate/signal format with layer since the RS operates at 40 G, 10 G, 2.5 G etc.)

The Auto-discovery technique attribute will be used to determine the technique that is the source of the data. It will become important to identify the technique once multiple techniques are in use, particularly if more than one technique is in use at a given layer. The auto-discovery technique could be an integer value that will be appended to the Auto-Discovery Enabled, Auto-Discovery Readable and Auto-Discovery signature attributes. Version control is another other reason for this attribute.

The Auto-discovery signature attribute will be used to determine connectivity in the network. This attribute can have a value of NULL or it can have an actual value. If, for instance, a facility that uses the section trace technique cannot find any auto-discovery data in those bytes (perhaps because it is connected to an NE that does not support auto-discovery), it would report a value of NULL. If the section trace can be read and is recognisable as auto-discovery data, the auto-discovery signature will contain the data in the signature in the form of a string. Setting of the Readable flag could imply that an NE is receiving an auto-discovery signal and it is stable, for example, it has received the same signal for three successive reads (arbitrary value).

As regards Auto-Discovery Signature, correlation of distinct ports is accomplished by uniquely identifying each port with a correlation tag signature, containing the information similar to the following:

IEEE System ID of the NE

Universal Port identifier, consisting of Shelf, Subshelf, Slot, Subslot, Port numbers, λ etc

The format of the signature can be printable ASCII characters for ease of debugging, troubleshooting and customer display but other formats, such as for example binary encoding, Unicode character encoding etc, are suitable. Auto-discovery message length needs to be long enough to accommodate future growth.

It is to be noted that the Auto-Discovery Signature described above is specific to the particular context in which it is described. However, the present technique, in accordance with the invention, is of far more general application. In this respect, the Auto-Discovery Signature consists, in general terms, of the following three data fields:

(1) universally unique identifier;

(2) locally (to the equipment) unique port identifier; and

(3) overhead, which may be used for the purposes of error detection and/or correction, identification of the network layer at which the autodiscovery protocol is operating, version control for autodiscovery protocol, or any other uses which serve to qualify or control the applicability, reliability or validation of the equipment and port identifier fields.

As regards (1), the universally unique equipment identifier must be a value which is guaranteed to be unique within the context of all autodiscovery devices. The ubiquity of IEEE System identifiers in communications network elements makes this a useful candidate. However, other identifiers could be used so long as the identifier can uniquely distinguish the network element.

As regards (2), the port identifier must uniquely identify a port only within the context of the network element equipment identified by (1). This port identifier may be a physical representation of the location of the port within the network element (eg shelf number, slot number, port number within a circuit pack etc). It may be an arbitrary logical identifier (eg sequential numbering of ports wihtin the equipment). It may be a wavelength (lambda) value so long as no other port within the network element uses the same wavelength.

As regards (3), the overhead portion of the signature can consist of any data which: can be used to validate the reliability of the remaining data (eg checksum, cyclical redundancy check {CRC} code etc); can provide a means to correct errors in the remaining portion of the signature (eg ECC codes); or can be a representation of the protocol version, layer identifier, or other data which the terminating equipment can use to validate that the format of the other data fields within the signature are comparable. For example, the way in which the unique equipment identifier and port identifier values are derived will depend on a specific instance of an autodiscovery protocol. A unique identifier for this protocol would be included in the overhead portion of the signature so that only signatures of the same format are treated as comparable.

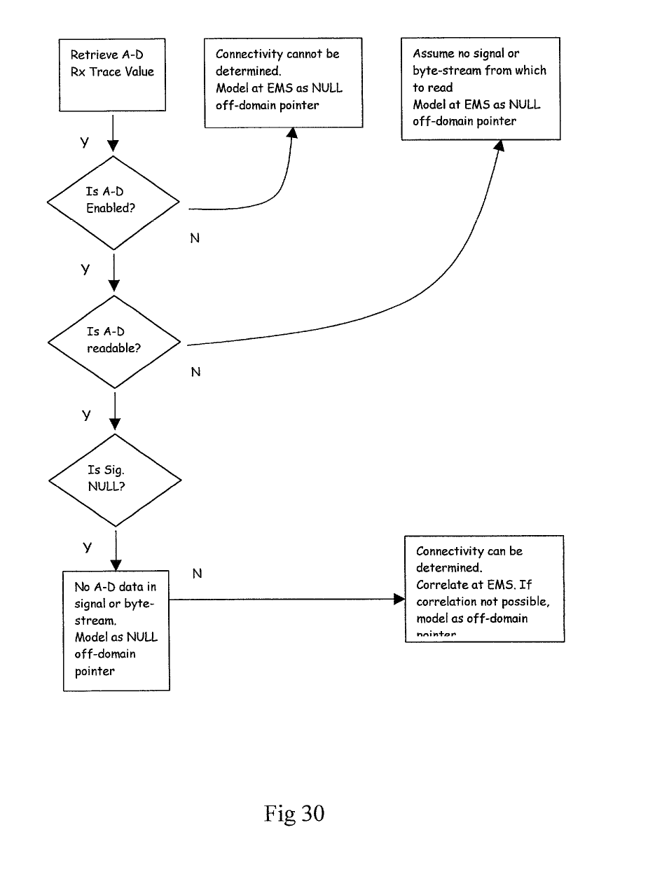

FIG. 30 illustrates how the above information may be used, assuming the NE Discovery process is complete & Tx values are known at EMS level.

Overview: At each layer, the Tx, the expected Rx, and the actual Rx will be modelled. Rx will be reported upwards. If expected Rx is provisioned, discrepancies will be flagged as mismatch alarms. Expected Rx can be provisioned at EMS by sucking up all the Rx values and, if this complies with user requirements, expected Rx can be configured to be actual Rx. If expected Rx is not provisioned or is set to ‘null’ then no mismatch alarms will be generated. Tx values are required for correlation.

If it is considered that there are too many alarms in the systems already, a detected condition can be provisioned as autonomously reportable as an unexpected change, and can be turned on or off. When turned off the condition can still be queried.

An alarm would indicate that some user operation needs to be performed. However an event could be hidden from users and used only by applications interested in topology. Most customers will want to know when topology has changed but care is needed to ensure that a customer building his network rapidly can disable all notification functionality. Acceptance of a reference topology should therefore be optional. Some customers may just want a current view and not the reference view. It may also be the case that the detected condition should be provisionable as some customers may not want notification or do not have a reference topology.

Auto-discovery should be turned off at FAC and NE level or, more accurately, turned off at the port and node level where port means different things at different layers. Turning off the Tx would solve interoperability problems with other vendor equipment. Turning off Rx trace would prevent bad discovery information caused by the same interoperability issues from being received. Performance may also be a reason for turning auto-discovery off.

Although the invention has been described in connection with an optical/SONET communication network, it is clearly of wider applicability and it is not intended that the present invention should be limited solely to optical networks. Moreover, the features described have been included so as to present the invention in its clearest form and to describe its operation in a specific context. It should be understood, however, that the features of the invention are of general applicability and are not to be constrained by the precise context within which it has been described for the purposes of conveying the best known method of implementation.

For example, autodiscovery can be used in a G.ASTN architecture (Automatic Switched Transport Network) to implement an automatic control plane on top of the optical network. Autodiscovery is used there to automatically detect the network topology, perform aggregation of optical network bandwidth into routable “trunks” of bandwidth, and to detect whether adjacent network elements are also within the same control network. This application is conmpletely separate from the context of trail management employed in the present description for the purposes of describing one particular application of the generality of the technique according to the present invention.

Glossary

| Term | Description |
|---|---|
| ADM | Add/Drop Multiplexer |
| APS ID | Automatic Protection Switch ID |
| BLSR | Bidirectional Line-switched Ring |
| CPG | Circuit Pack Group |
| CS | Connection Services |
| CTA | Configurable Trail Adapter |
| CTP | Connection Termination Point |
| EC | Element Controller |
| MOA | Managed Object Agent |
| NE | Network Element |
| OPC | Operations Controller |
| RHE | Requirements, High-level design, and Estimates |
| SDH | Synchronous Digital Hierarchy |
| SOC | Span of Control |
| SONET | Synchronous Optical Network |
| TL1 | Transaction Language 1 |
| TM | Trail Manager |
| TMO | OPC process acting as the interface between TM and |
| | the OPC CS Base, also known as TM Sever. |
| TP | Termination Point |
| TTP | Trail Termination Point |
| XDR | External Data Representation |

What we claim is:

1. A method for determining the connectivity of nodes in a communication network comprising a plurality of interconnected nodes, the method comprising transmitting into the network a signal from each node, the signal constituting a signature unique to that node, detecting unique signature data from every transmitter and receiver, and correlating the detected data to determine the physical connectivity of the network.

2. A method as claimed in claim 1, further comprising the step of each node reporting transmission of a unique signature and detection of a unique signature to a network manager controlling the network.

3. A method as claimed in claim 2, further comprising the step wherein a node that was previously receiving a valid unique signature does not report detection of an invalid signature, whereby to prevent the network manager effecting changes under fault conditions.

4. A method as claimed in claim 2, further comprising the step wherein under circumstances in which a node has not detected a unique signature matching a transmitted signature, the network manager creates an off-network pointer for the said node.

5. A method as claimed in claim 2, further comprising the steps of establishing a unidirectional trail in the network manager from a second node to a first node when the first node detects the unique signature of the second node; establishing a unidirectional trail in the network manager from the first node to the second node when the second node detects the unique signature of the first node; and thereby establishing a bidirectional trail between the first node and the second node.

6. A communication network comprising a plurality of interconnected nodes, the network provided with means for determining the connectivity of said nodes, comprising a transmitter per node for transmitting into the network a signature signal from each node, the signal constituting a signature unique to that node, a detector per node for detecting unique signature data received at each said node, and a correlator for correlating the detected unique signature data to determine the physical connectivity of the network.

7. A communication network as claimed in claim 6, further comprising reporting means whereby each node reports transmission of a unique signature and detection of a unique signature to a network manager controlling the network.

8. A communication network as claimed in claim 7, further comprising blocking means whereby a node that was previously receiving a valid unique signature does not report detection of an invalid signature, whereby to prevent the network manager effecting changes under fault conditions.

9. A communication network as claimed in claim 2, further comprising off-network pointer creating means whereby, when a node has not detected a unique signature matching a transmitted signature, the network manager creates an off-network pointer for the said node.

10. A communication network as claimed in claim 2, further comprising trail establishing means whereby to establish a unidirectional trail in the network manager from a second node to a first node when the first node detects the unique signature of the second node; establish a unidirectional trail in the network manager from the first node to the second node when the second node detects the unique signature of the first node; and thereby to establish a bidirectional trail between the first node and the second node.

11. A communication network as claimed in claim 6, wherein the network is an optical communication network.

12. A network manager for a communication network, the communication network comprising a plurality of interconnected nodes, the network manager provided with correlator means for determining the connectivity of said nodes in response to detection at each node of unique signature signals transmitted into the network from each node, said correlator means adapted to correlate the detected unique signature signals to determine the physical connectivity of the network.

13. A media carrying a computer program adapted to perform the method of claim 1.

14. A media carrying a computer program adapted to perform the function of the network manager according to claim 6.

15. A computer program adapted to perform the method of claim 1.

16. A computer program adapted to perform the function of the network manager according to claim 6.
